(19) United States
(12) Patent Application Publication
(10) Pub. No.: US 2025/0220563 A1
(43) Pub. Date: Jul. 3, 2025

(54) NETWORK SLICING HIGH AVAILABILITY METHOD, APPARATUS, DEVICE, AND STORAGE MEDIUM

(71) Applicant: Lenovo (Beijing) Limited, Beijing (CN)

(72) Inventors: Nu DAI, Beijing (CN); Wuwen LIU, Beijing (CN); Jianguang CUI, Beijing (CN)

(21) Appl. No.: 19/000,678

(22) Filed: Dec. 23, 2024

(30) Foreign Application Priority Data
Dec. 31, 2023 (CN) 202311873534.0

(51) Int. Cl. H04W 48/16; H04W 28/16

(52) U.S. Cl. CPC H04W 48/16; H04W 28/16

(57) ABSTRACT

A network slice high-availability method includes determining at least one network slice. Each network slice of the at least one network slice includes at least one network element container. Network element containers of the network slice are distributed at different network nodes. Labels of network slices are used to distinguish different network slices. Resources are isolated among a plurality of network slices. Resources are shared among network slices of a same type. Network containers of the network slices realize high availability for resources.

### CROSS REFERENCE TO RELATED APPLICATION

The present disclosure claims priority to Chinese Patent Application No. 202311873534.0, filed on Dec. 31, 2023, the entire content of which is incorporated herein by reference.

### TECHNICAL FIELD

The present disclosure is related to the 5G communication technology field and, more particularly, to a network slicing high availability method, a network slicing high availability apparatus, a device, and a storage medium.

### BACKGROUND

In the 5G era, a single physical network no longer meets service level agreement (SLA) requirements of various vertical industries. The personalized and differentiated business needs lead to the creation of 5G network slicing.

In related technologies, if a node deployed by a network slice fails, the network slice is not able to provide services.

### SUMMARY

One aspect of the present disclosure provides a network slice high-availability method. The method includes determining at least one network slice. Each network slice of the at least one network slice includes at least one network element container. Network element containers of the network slice are distributed at different network nodes. Labels of network slices are used to distinguish different network slices. Resources are isolated among a plurality of network slices. Resources are shared among network slices of the same type. Network containers of the network slices realize high availability for resources.

Another aspect of the present disclosure provides a network slice high-availability apparatus, including a determination module. The determination module is configured to determine at least one network slice. Each network slice of the at least one network slice includes at least one network element container. Network element containers of the network slice are distributed at different network nodes. Labels of network slices are used to distinguish different network slices. Resources are isolated among a plurality of network slices. Resources are shared among network slices of the same type. Network containers of the network slices realize high availability for resources.

Another aspect of the present disclosure provides an electronic device including one or more memories and one or more processors. The one or more memories store a computer program that, when executed by the one or more processors, causes the one or more processors to determine at least one network slice. Each network slice of the at least one network slice includes at least one network element container. Network element containers of the network slice are distributed at different network nodes. Labels of network slices are used to distinguish different network slices. Resources are isolated among a plurality of network slices. Resources are shared among network slices of the same type. Network containers of the network slices realize high availability for resources.

### BRIEF DESCRIPTION OF THE DRAWINGS

FIG. 1 illustrates a schematic flowchart of a network slicing high availability method according to some embodiments of the present disclosure.

FIG. 2 illustrates a schematic diagram of a network slicing according to some embodiments of the present disclosure.

FIG. 3 illustrates a schematic flowchart of another network slicing high availability method according to some embodiments of the present disclosure.

FIG. 4 illustrates a schematic diagram of another network slicing according to some embodiments of the present disclosure.

FIG. 5 illustrates a schematic flowchart of another network slicing high availability method according to some embodiments of the present disclosure.

FIG. 6 illustrates a schematic flowchart of another network slicing high availability method according to some embodiments of the present disclosure.

FIG. 7 illustrates a schematic flowchart of another network slicing high availability method according to some embodiments of the present disclosure.

FIG. 8 illustrates a schematic structural diagram of a network slicing high availability apparatus according to some embodiments of the present disclosure.

FIG. 9 illustrates a schematic structural diagram of an electronic device according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure.

Currently, as a key infrastructure of a digital society, a 5G network is no longer limited to the business field of traditional mobile communication networks. The 5G network needs to satisfy digital transformation needs of various industries. In the 5G era, many vertical industry applications are provided. Each business can have a large difference in the requirements for latency, bandwidth, and connection number. Therefore, three typical application scenarios are defined in 5G, including Enhanced Mobile Broadband (eMBB), Ultra-reliable and Low Latency Communications (uRLLC), and Massive Machine Type Communication (mMTC).

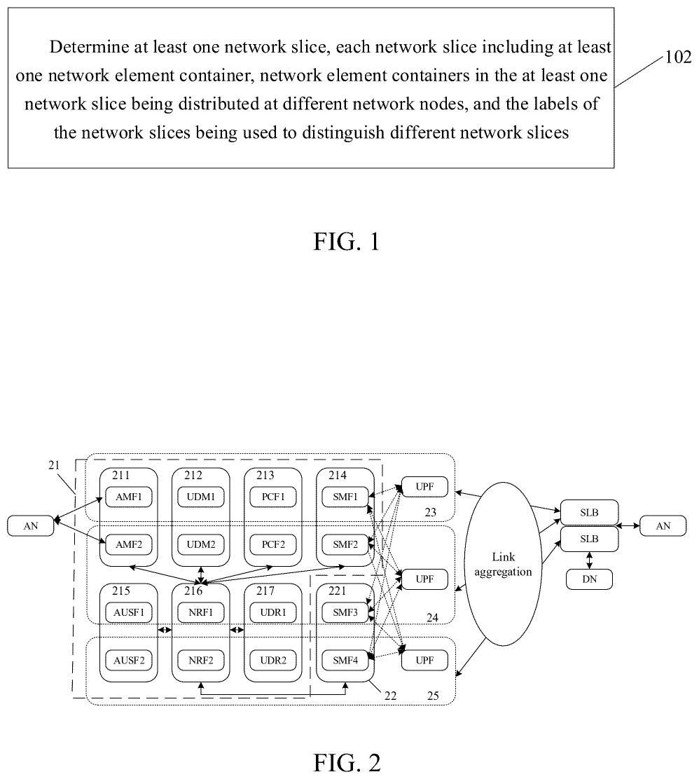

FIG. 1 illustrates a schematic flowchart of a network slicing high availability method according to some embodiments of the present disclosure. As shown in FIG. 1, the method includes the following steps.

At step 102, at least one network slice is determined, each network slice includes at least one network element container, network element containers in the at least one network slice are distributed at different network nodes, and the labels of the network slices are used to distinguish different network slices.

Resources can be isolated between a plurality of network slices. Resources can be shared between network slices of the same type. High availability of the resources can be realized within the network element container of the network slice.

Network slicing is a method of on-demand networking that allows an operator to separate a plurality of virtual end-to-end networks on a unified infrastructure. Each network slice can be logically isolated from a radio access network to a carrier network and then to a core network to adapt to various types of applications. A network slice can at least include a wireless sub-slice, a carrier network sub-slice, and a core network sub-slice.

Since the network slice can be configured to implement the business functions, completing the businesses of the whole network slice may need cooperation among the functional modules corresponding to many network element containers to implement the functions. The network slices of the same type can be network slices of implementing the same business. Thus, each network slice can include at least one type of network element container. One network element container can be configured to implement one function. A network slice of the network slices of the same type that is deployed first can include all the network element containers required to implement the whole business. A network slice that is deployed later can include a part of the network element containers required to implement the business, and the other part of the network element containers required to implement the business can directly call the network element containers in the network slice deployed first. Thus, the resources among the network slices of the same type can be shared, and the network slices that are deployed later can be deployed quickly. Moreover, the network slices deployed later can also implement the whole business. The network element container can run in the form of pod of a virtual platform K8 to ensure the isolation of the resources among different network element containers and quick deployment of the resources among the network element containers.

As shown in FIG. 2, a first network slice 21 and a second network slice 22 are determined. The first network slice 21 includes network element containers such as AMF (Access and Mobility Management Function), UDM (Unified Data Management), PCF (Policy Control Function), SMF (Session Management Function), AUSF (Authentication Server Function), NRF (NF Repository Function), and UDR (Unified Data Repository). The second network slice 22 includes a network element container SMF. One network element container can correspond to one functional module. The first network slice can include functional modules 211 to 217, and the second network slice can include a functional module 221.

In a 5G network, AMF is a core unit and is responsible for registration, connection, reachability, mobility, security and access management, and business authorization. UDM is responsible for user identification management, subscription data management, authentication data management, and user service network element registration management (for example, AMF and SMF that currently provide services to the terminal, when the user switches the accessed AMF, UDM initiates a deregistration message to the old AMF to require the old AMF to delete user-related information). PCF supports a unified policy framework to manage network behavior to provide policy rules to a network entity for implementation, and access subscription information of the unified data repository (UDR). SMF is responsible for tunnel maintenance, IP address allocation and management, UP function selection, policy implementation, and control, charging data collection, and roaming of QoS. AUSF is configured to receive a request of the AMF to perform verification on the UE to request a key from UDM and forward the key issued by UDM to AMF for authentication processing. An NRF function is a new function that provides registration and a discovery function to allow network functions (NF) to discover each other and communicate through API interfaces. UDR is used by UDM to store or read subscription data and by PCF to store or read policy data.

The network element container includes a shared network element and an independent network element. Considering the high availability of the business, the same type of network element containers of the first network slice 21 or the second network slice 22 can be distributed at different network nodes. The network element container AMF corresponding to the functional module 211 can include network element container AMF1 distributed at a first network node 23 and AMF2 distributed at a second network node 24. The network element container UDM corresponding to a functional module 212 can include network element container UDM1 distributed at a first network node 23 and UDM2 distributed at a second network node 24. The network element container PCF corresponding to a functional module 213 can include network element container PCF1 distributed at the first network node 23 and PCF2 distributed at the second network node 24. The network element container SMF corresponding to a functional module 214 can include network element container SMF1 distributed at the first network node 23 and SMF2 distributed at the second network node 24. The network element container AUSF corresponding to a functional module 215 can include network element container AUSF1 distributed at the second network node 24 and AUSF2 distributed at a third network node 25. The network element container NRF corresponding to a functional module 216 can include network element container NRF1 distributed at the second network node 24 and NRF2 distributed at the third network node 25. The network element container UDR corresponding to a functional module 217 can include network element container UDR1 distributed at the second network node 24 and UDR2 distributed at the third network node 25. The network element container SMF corresponding to a functional module 221 can include network element container SMF3 distributed at the second network node 24 and SMF4 distributed at the third network node 25.

The same network slice can be assigned with the same label, and different network slices can be assigned with different labels. For example, the functional modules 211 to 217 of the first network slice 21 can be assigned with the same label, and the second network slice 22 can be assigned a different label from the first network slice 21.

Since different network element containers need to cooperate, the different network element containers need to exchange information. For example, when a business is initiated, the business can first reach network element container AMF1. When AMF1 needs to pass the information down, information exchange can be required. The arrows in FIG. 2 can indicate the information exchange among the network element containers.

The resource isolation among the network slices can indicate that the resources occupied by the network element containers of the network slice can be independent and may not interfere with each other. Even if the business pressure of a network element container of one network slice is very high, a network element container of the same type of another network slice may not be affected. The resource sharing among the network slices can indicate that the resources occupied by the network element container of the network slice can be shared, and the business of the first network slice can be operated at a network element container of another network slice.

As shown in FIG. 2, the resource isolation is that network element containers SMF1 and SMF2 at the functional module 214 of the first network slice 21 only carry the business of the first network slice 21, and network element containers SMF3 and SMF4 at the functional module 221 of the second network slice 22 only carry the business of the second network slice 22. The resources occupied by SMF1 and SMF2 of the first network slice 21 are independent of and do not interfere with the resources occupied by SMF3 and SMF4 of the second network slice 22. Even if the business pressure of SMF1 is very high, SMF3 may not be affected.

The resource sharing can also be that the business of the second network slice 22 can be operated at the network element containers such as AMF, UDM, PCF, AUSF, NRF, and UDR with relatively low business pressure in the first network slice 21.

In embodiments of the present disclosure, the network slice can be quickly deployed and managed through the virtualization technology pod. The resource isolation can be achieved between the network slices, the resources can be planned as needed, and may not interfere with each other. The resources can be shared among the network slices. The network element containers can be distributed at different network nodes to realize the high availability of the resources.

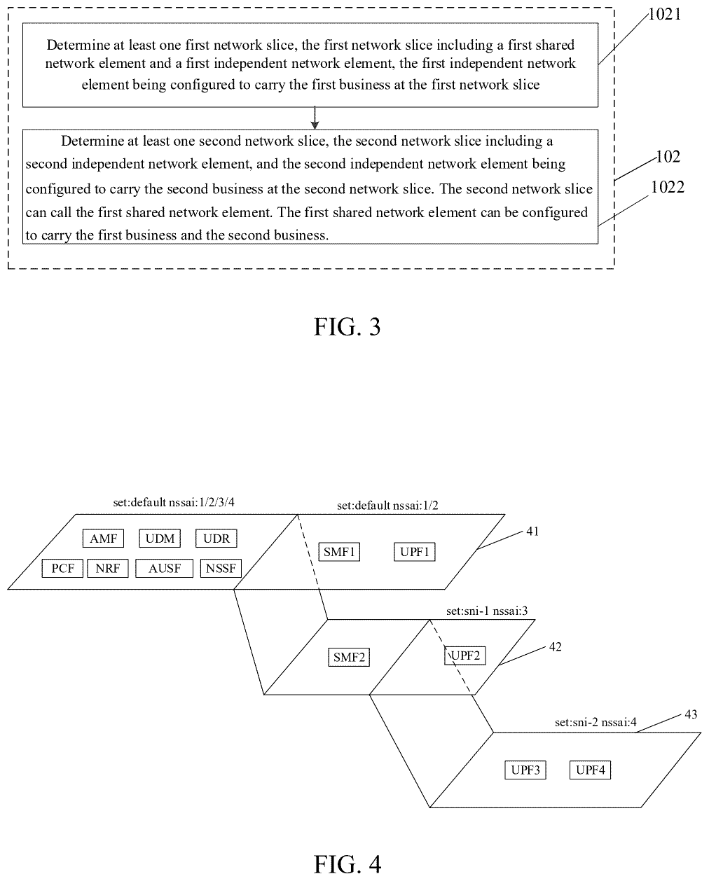

In some embodiments, as shown in FIG. 3, the network element container includes a shared network element and an independent network element. In step 102, determining the at least one network slice includes the following processes.

At 1021, at least one first network slice is determined. The first network slice includes a first shared network element and a first independent network element. The first independent network element is configured to carry the first business at the first network slice.

At 1022, at least one second network slice is determined. The second network slice includes a second independent network element. The second independent network element is configured to carry the second business at the second network slice.

The second network slice can call the first shared network element. The first shared network element can be configured to carry the first business and the second business.

As shown in FIG. 2, the first network slice 21 includes first shared network elements AMF, UDM, PCF, AUSF, NRF, and UDR, and first independent network elements SMF1 and SMF2. The first independent network elements SMF1 and SMF2 can carry the first business at the first network slice 21. The second network slice includes second independent network elements SMF3 and SMF4. The second independent network elements SMF3 and SMF4 can carry the second business at the second network slice 22. The second network slice 22 can call the first shared network elements AMF, UDM, PCF, AUSF, NRF, and UDR. The first shared network elements AMF, UDM, PCF, AUSF, NRF, and UDR can be configured to carry the first business and the second business.

As shown in FIG. 4, the first network slice 41 includes first shared network elements AMF, UDM, UDR, PCF, NRF, AUSF, and NSSF (Network Slice Selection Function), and first independent network elements SMF1 and UPF1 (User Plane Function). NSSF can be configured to determine a network slice instance that the UE is allowed to access according to the slice selection assistance information and subscription information of the UE. UPF can be configured to implement packet routing and forwarding, policy implementation, traffic reporting, and QoS processing. UPF can be an anchor point of a conversation and record a traffic forwarding volume.

The first independent network elements SMF1 and UPF1 can only carry the first business at the first network slice 41. The second network slice 42 includes second independent network elements SMF2 and UPF2. The second independent network elements SMF2 and UPF2 can carry the second business at the second network slice 42. The second network slice 42 can call the first shared network elements AMF, UDM, UDR, PCF, NRF, AUSF, and NSSF. The first shared network elements AMF, UDM, UDR, PCF, NRF, AUSF, and NSSF can be configured to carry the first business and the second business.

In embodiments of the present disclosure, the network slice can include the shared network elements and the independent network elements. Thus, the resources can be shared among the network slices through the shared network elements, and the resources can be isolated among the network slices through the independent network elements. Since the network slice deployed later can call the shared network elements of the network slice deployed earlier, the network slices can be quickly deployed.

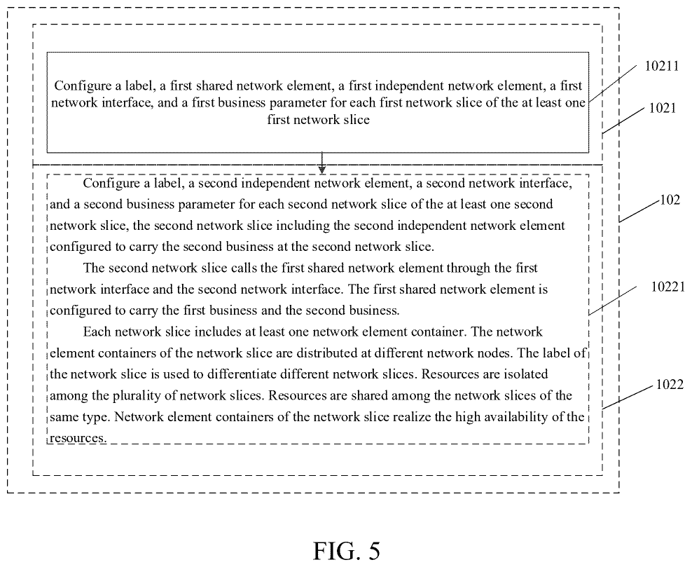

In some embodiments, as shown in FIG. 5, in step 1021, determining the at least one first network slice includes the following processes.

At 10211, a label, a first shared network element, a first independent network element, a first network interface, and a first business parameter are configured for each first network slice of the at least one first network slice.

In step 1022, determining the at least one second network slice includes, at 10221, a label, a second independent network element, a second network interface, and a second business parameter are configured for each second network slice of the at least one second network slice.

The at least one second network slice can call the first shared network element through the first network interface and the second network interface.

The first business parameter can be a parameter required for the first business, and the second business parameter can be a parameter required for the second business. When a new second network slice is constructed, the shared network element of the constructed first network slice can be called after the second network slice is defined, and the reference path can be indicated (i.e., the calling network interface) to call the resources in the shared network element.

In embodiments of the present disclosure, by specifying the calling interface, the resources can be called more efficiently and accurately.

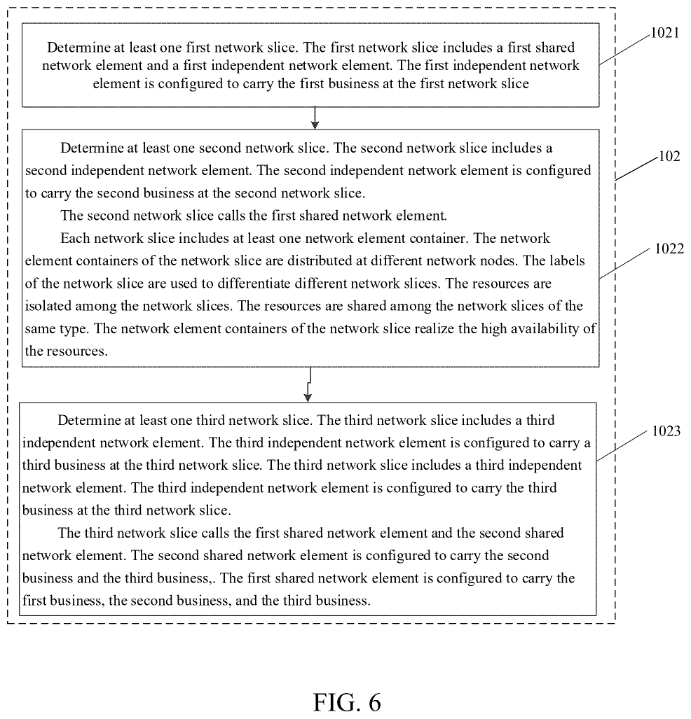

In some embodiments, as shown in FIG. 6, the second independent network element includes a second shared sub-network element and a second independent sub-network element. In step 102, determining the at least one network slice includes, at 1023, determining at least one third network slice. The third network slice includes a third independent network element. The third independent network element is configured to carry a third business at the third network slice.

The third network slice can be configured to call the first shared network element and the second shared sub-network element. The second shared sub-network element can be configured to carry the second business and the third business. The first shared network element can be configured to carry the first business, the second business, and the third business.

As shown in FIG. 4, the second independent network elements SMF2 and UPF2 include a second shared sub-network element SMF2 and a second independent sub-network element UPF2. The third network slice 43 includes third independent network elements UPF3 and UPF4. The third independent network elements UPF3 and UPF4 can be configured to carry the third business at the third network slice 43. The third network slice 43 can call the first shared network elements AMF, UDM, UDR, PCF, NRF, AUSF, and NSSF, as well as the second shared sub-network element SMF2. The second shared sub-network element SMF2 can be configured to carry the second business and the third business. The first shared network elements AMF, UDM, UDR, PCF, NRF, AUSF, and NSSF can be configured to carry the first business, the second business, and the third business.

In embodiments of the present disclosure, the network slice can include the shared network element and the independent network element. Thus, the resources can be shared among the network slices through the shared network element, and the resources can be isolated among the network slices through the independent network element. Since the later-deployed network slice can call the shared network element of the previously deployed network slice, the network slices can be deployed quickly.

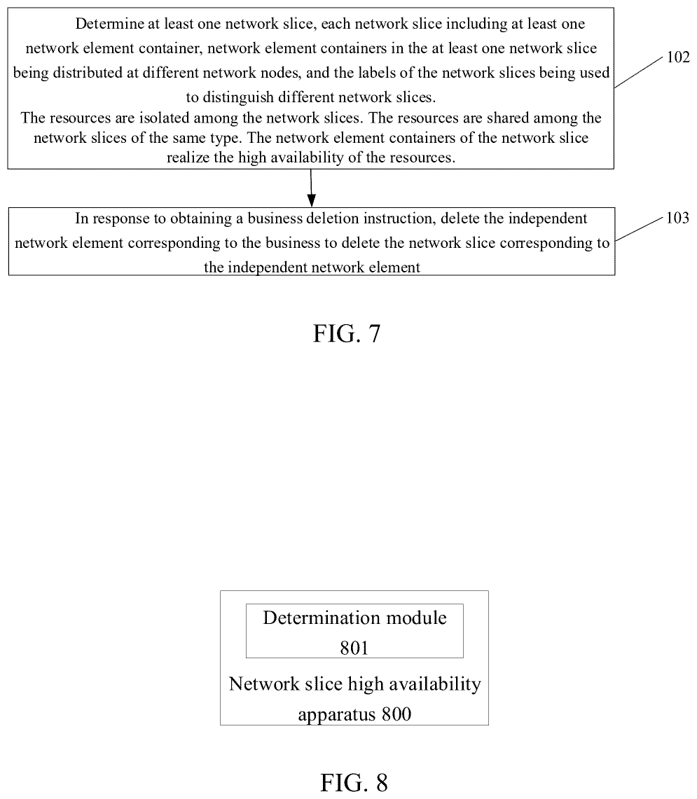

In some embodiments, as shown in FIG. 7, the method further includes, at 103, in response to obtaining a business deletion instruction, deleting the independent network element corresponding to the business to delete the network slice corresponding to the independent network element.

As shown in FIG. 2, when the second independent network elements SMF3 and SMF4 are deleted, the second network slice 22 corresponding to the second independent network elements SMF3 and SMF4 is deleted. As shown in FIG. 4, when the second independent network element UPF2 is deleted, the second network slice 42 corresponding to the second independent network element UPF2 is deleted. When the third independent network elements UPF3 or UPF4 are deleted, the third network slice 43 corresponding to the third independent network elements UPF3 or UPF4 is deleted.

In embodiments of the present disclosure, by deleting the independent network element corresponding to the business, the network slice corresponding to the independent network element can be quickly deleted to restore the resources efficiently and rapidly.

In some embodiments, each network slice can include two network element containers of the same type, which are running at different network nodes and configured to start a network element container of the same type at another network node when the network element container of any network node fails.

If the network element container is only distributed at one node, no service can be provided when the node has a power outage or fails. Thus, the network element containers of the same type can be running at different network nodes to use one network element of the network element containers of the same type as a backup.

In embodiments of the present disclosure, by running the network element containers of the same type at different network nodes, the high availability of the business can be realized.

In some embodiments, the business parameters of each network slice can be different.

Each network slice can correspond to an application scenario. The application scenario can include any one of eMBB, uRLLC, and mMTC.

In embodiments of the present disclosure, different application scenarios can correspond to different network slices to allow the different network slices to realize different businesses and be applied to different scenarios to improve the service capability of the network slices.

In embodiments of the present disclosure, the K8S platform can be used as a basis. All network elements can run in the form of pod to ensure the resource isolation and the resource rapid deployment among different network elements. Each network slice can include different network element containers. Different network slices can be differentiated by setting labels. The network element pods of the same slice can be set with the same label to facilitate general management.

Different network slices can be provided with different network interfaces and configured with different business parameters to allow the different slices to provide differentiated service capabilities.

In embodiments of the present disclosure, the network slice deployment process can include the following processes.

At S201, the 5GC core network is normally deployed.

At S202, a slice name and a network element are configured for a newly added slice.

At S203, a network interface is configured for the new slice.

At S204, the network element of the new slice is started.

At S205, business configuration information of the new slice is configured.

Using cloud-native virtualization technology to deploy and manage the 5GC slice network elements can quickly complete the deployment and management of the network slices. The resource can be isolated among the network slices. The resources can be planned as needed without interfering with each other. Through the shared network elements, the resources can be shared among the slices. To rapidly uninstall the slices, the resources can be quickly restored.

In embodiments of the present disclosure, if the above network switching high-availability method is implemented in the form of software functional modules and sold or used as an independent product, the method can also be stored in a computer-readable storage medium. Based on this understanding, the essence of the technical solutions of embodiments of the present disclosure or the part of the technical solutions of embodiments of the present disclosure contributing to the related technology can be embodied as a software product. The computer software product can be stored in a storage medium and include several instructions to allow an electronic device (e.g., a cell phone, tablet, desktop computer, personal digital assistant, navigator, digital phone, video phone, TV, sensor device, etc.) to execute all or part of the method in embodiments of the present disclosure. The storage medium can include various media that can store program codes, such as USB flash drives, a mobile hard drive, read-only memory (ROM), magnetic disks, or optical disks. Thus, embodiments of the present disclosure are not limited to any specific hardware and software combination.

FIG. 8 illustrates a schematic structural diagram of a network slicing high availability apparatus 800 according to some embodiments of the present disclosure. The apparatus 800 includes a determination module 801.

The determination module 801 can be configured to determine the at least one network slice. Each network slice includes at least one network element container. The network element containers of the network slice are distributed at different network nodes. The labels of the network slices are used to distinguish different network slices.

The resources can be isolated among the plurality of network slices. The resources can be shared among the network slices of the same type. The network element containers of the network slice can realize the high availability of the resources.

In some embodiments, the network element container can include a shared network element and an independent network element. The determination module 801 can include a first determination sub-module and a second determination sub-module. The first determination sub-module can be configured to determine at least one first network slice. The first network slice can include a first shared network element and a first independent network element. The first independent network element can be configured to carry the first business at the first network slice. The second determination sub-module can be configured to determine at least one second network slice. The second network slice can include a second independent network element. The second independent network element can be configured to carry the second business at the second network slice. The second network slice can be configured to call the first shared network element. The first shared network element can be configured to carry the first business and the second business.

In some embodiments, the first determination sub-module can include a first configuration unit, a first shared network element, a first independent network element, a first network interface, and a first business parameter. The first configuration unit can be configured to configure the label for each first network slice of the at least one first network slice.

The second determination sub-module can include a second configuration unit, a second independent network element, a second network interface, and a second business parameter. The second configuration unit can be configured to configure the label for each second network slice of the at least one second network slice. The at least one second network slice can call the first shared network element through the first network interface and the second network interface.

In some embodiments, the second independent network element can include a second shared sub-network element and a second independent sub-network element. The determination module 801 can further include a third determination sub-module configured to determine at least one third network slice. The third network slice can include a third independent network element. The third independent network element can be configured to carry the third business at the third network slice. The third network slice can call the first shared network element and the second shared network element. The second shared network element can be configured to carry the second business and the third business. The first shared network element can be configured to carry the first business, the second business, and the third business.

In some embodiments, the apparatus can also include a deletion module configured to delete the independent network element corresponding to the business in response to obtaining the business deletion instruction to delete the network slice corresponding to the independent network element.

In some embodiments, each network slice can include two network element containers of the same type, which are running at different network nodes. Thus, when the network element container of any one network node fails, the network element container of the same type at the other node can be started.

In some embodiments, the business parameters of each network slice can be different.

The description of the above apparatus embodiments can be similar to the description of the method embodiments and can have similar beneficial effects as the method embodiments. For the technical details not disclosed in the apparatus embodiments of the present disclosure, reference can be made to the description of the method embodiments of the present disclosure.

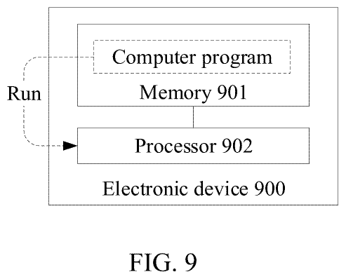

Based on the above, embodiments of the present disclosure further provide an electronic device. FIG. 9 illustrates a schematic structural diagram of an electronic device 900 according to some embodiments of the present disclosure. As shown in FIG. 9, the hardware entity of the device 900 includes one or more memories 901 and one or more processors 902. The one or more memories 901 can be used to store a computer program running at the one or more processors 902. When the one or more processors 902 executes the program, the steps of the above network slice high-availability method can be implemented.

The one or more memories 901 can be configured to store instructions and applications executable by the one or more processors 902 and also cache to-be-processed or processed data by the one or more processors 902 and various modules of the device 900 (e.g., image data, audio data, voice communication data, and video communication data), which can be realized through flash memory (FLASH) or random access memory (RAM).

Based on the above, embodiments of the present disclosure further provide a computer-readable storage medium. The computer-readable storage medium can store a computer program that, when executed by the one or more processors of the electronic device, causes the one or more processors to implement the network slice high-availability method above.

The descriptions of embodiments of the present disclosure are intended to emphasize the differences among embodiments of the present disclosure. The same or similar parts can be referred to each other, which are not repeated for simplicity.

The methods disclosed in the various method embodiments of the present disclosure can be combined arbitrarily to obtain new method embodiments, as long as there is no conflict.

The features disclosed in the various product embodiments of the present disclosure can be combined arbitrarily to obtain new product embodiments, as long as there is no conflict.

The features disclosed in the various method or device embodiments of the present disclosure can be combined arbitrarily to obtain new method or device embodiments, as long as there is no conflict.

The above computer-readable storage medium can include read-only memory (ROM), programmable read-only memory (PROM), erasable programmable read-only memory (EPROM), electrically erasable programmable read-only memory (EEPROM), ferromagnetic random access memory (FRAM), flash memory, magnetic surface memory, optical disk, or compact disc read-only memory (CD-ROM), etc. In some other embodiments, the computer-readable storage medium can also include various electronic devices including one or any combination of the above storage media, such as cell phones, computers, tablet devices, personal digital assistants, etc.

The terms “include,” “comprise,” or any other variants thereof are intended to cover non-exclusive inclusion, so that a process, method, article, or apparatus that includes a series of elements not only includes those elements but also includes other elements not explicitly listed, or further includes elements inherent to such a process, method, article, or apparatus. Without further limitations, an element defined by the phrase “including a . . . ” does not exclude the existence of additional identical elements in the process, method, article, or apparatus that includes the element.

The numbers of embodiments in the present disclosure are only for description and do not represent the advantages or disadvantages of embodiments of the present disclosure.

Through the description of the above embodiments, those skilled in the art can clearly understand that the above method embodiments can be implemented by software plus necessary general hardware nodes, and of course by hardware. However, in many cases, the software can be a preferred implementation. Based on this understanding, the technical solutions of the present disclosure can essentially be embodied as a software product. The computer software product can be stored in a storage medium (e.g., ROM/RAM, magnetic disk, optical disk) and includes several instructions to cause a terminal device (e.g., a cell phone, computer, server, air conditioner, or network device, etc.) to execute the methods described in embodiments of the present disclosure.

The present disclosure is described with reference to the flowcharts and/or block diagrams of the methods, devices (systems), and computer program products according to embodiments of the present disclosure. Each flow and/or block in the flowcharts and/or block diagrams and combinations of flows and/or blocks in the flowcharts and/or block diagrams can be implemented by the computer program instructions. The computer program instructions can be provided to a general-purpose computer, special-purpose computer, embedded processor, or other programmable data processing device to produce a machine. Thus, the instructions performed by processors of the computer or other programmable data processing device can be used to produce an apparatus of implementing one process or more processes of the flowchart and/or the determined function of one or more blocks of the block diagram.

The computer program instructions can also be stored in a computer-readable storage medium that can boot a computer or other programmable data processing device to operate in a specific manner. Thus, the instructions stored in the memory of the computer can produce a manufactured product including the instruction apparatus. The instruction apparatus can implement one or more processes of the flowchart and/or the functions determined by one or more blocks of the block diagram.

The computer program instructions can be loaded to the computer or other programmable data processing device to perform a series of operations at the computer or other programmable devices to realize the processing implemented by the computer. Thus, the instructions performed on the computer or other programmable device can provide steps of implementing one or more processes of the flowchart and/or functions determined in one or more blocks of the block diagram.

The above are some embodiments of the present disclosure and do not limit the scope of the present disclosure. Any equivalent structure or equivalent process transformation made using the content of the present disclosure and the accompanying drawings, or directly or indirectly applied to other related technical fields, are all included in the scope of the present disclosure.

What is claimed is:

1. A network slice high-availability method comprising:
determining at least one network slice, each network slice of the at least one network slice including at least one network element container, network element containers of the network slice being distributed at different network nodes, and labels of network slices are used to distinguish different network slices;
wherein:
resources are isolated among a plurality of network slices;
resources are shared among network slices of a same type; and
network containers of the network slices realize high availability for resources.

2. The method according to claim 1, wherein:
the network element container includes a shared network element and an independent network element; and
determining the at least one network slice includes:
determining at least one first network slice, a first network slice including a first shared network element and a first independent network element, the first independent network element being configured to carry a first business at the first network slice; and
determining at least one second network slice, a second network slice including a second independent network element and calling the first shared network element, the second independent network element being configured to carry a second business at the second network slice, and the first shared network element being configured to carry the first business and the second business.

3. The method according to claim 2, wherein:
determining the at least one first network slice includes:
configuring a label, the first shared network element, the first independent network element, a first network interface, and a first business parameter for each first network slice of the at least one first network slice;
determining the at least one second network slice includes:
configuring a label, the second independent network element, a second network interface, and a second business parameter for each second network slice of the at least one second network slice;
the at least one second network slice calls the first shared network element through the first network interface and the second network interface.

4. The method according to claim 3, wherein:
the second independent network element includes a second shared sub-network element and a second independent sub-network element;
determining the at least one network slice further includes:
determining at least one third network slice including a third independent network element, the third independent network element being configured to carry the third business at the third network slice; and
the third network slice calls the first shared network element and the second shared network element, the second shared network element being configured to carry the second business and the third business, and the first shared network element being configured to carry the first business, the second business, and the third business.

5. The method according to claim 1, further comprising:
in response to obtaining a business deletion instruction, deleting the independent network element corresponding to the business to delete the network slice corresponding to the independent network element.

6. The method according to claim 1, wherein:
each network slice includes two element containers of a same type running at different network nodes; and
when a network element container of any one network node fails, a network element container of the other network node is started.

7. The method according to claim 1, wherein each network slice has a different business parameter.

8. A network slice high-availability apparatus comprising:
a determination module configured to determine at least one network slice, each network slice of the at least one network slice including at least one network element container, network element containers of the network slice being distributed at different network nodes, and labels of network slices are used to distinguish different network slices;
wherein:
resources are isolated among a plurality of network slices;
resources are shared among network slices of a same type; and
network containers of the network slices realize high availability for resources.

9. The apparatus according to claim 8, wherein:
the network element container includes a shared network element and an independent network element; and
the determination module is further configured to:
determine at least one first network slice, a first network slice including a first shared network element and a first independent network element, the first independent network element being configured to carry a first business at the first network slice; and
determine at least one second network slice, a second network slice including a second independent network element and calling the first shared network element, the second independent network element being configured to carry a second business at the second network slice, and the first shared network element being configured to carry the first business and the second business.

10. The apparatus according to claim 9, wherein:
the determination module is further configured to:
configure a label, the first shared network element, the first independent network element, a first network interface, and a first business parameter for each first network slice of the at least one first network slice; and
configure a label, the second independent network element, a second network interface, and a second business parameter for each second network slice of the at least one second network slice; and
the at least one second network slice calls the first shared network element through the first network interface and the second network interface.

11. The apparatus according to claim 10, wherein:
the second independent network element includes a second shared sub-network element and a second independent sub-network element;
the determination module is further configured to:
determine at least one third network slice including a third independent network element, the third independent network element being configured to carry the third business at the third network slice; and
the third network slice calls the first shared network element and the second shared network element, the second shared network element being configured to carry the second business and the third business, and the first shared network element being configured to carry the first business, the second business, and the third business.

12. The apparatus according to claim 8, further comprising:
a deletion module configured to, in response to obtaining a business deletion instruction, delete the independent network element corresponding to the business to delete the network slice corresponding to the independent network element.

13. The apparatus according to claim 8, wherein:
each network slice includes two element containers of a same type running at different network nodes; and
when a network element container of any one network node fails, a network element container of the other network node is started.

14. An electronic device comprising:
one or more processors; and
one or more memories storing a computer program that, when executed by the one or more processors, causes the one or more processors to:
determine at least one network slice, each network slice of the at least one network slice including at least one network element container, network element containers of the network slice being distributed at different network nodes, and labels of network slices are used to distinguish different network slices;
wherein:
resources are isolated among a plurality of network slices;
resources are shared among network slices of a same type; and
network containers of the network slices realize high availability for resources.

15. The device according to claim 14, wherein:
the network element container includes a shared network element and an independent network element; and
the one or more processors are further configured to:
determine at least one first network slice, a first network slice including a first shared network element and a first independent network element, the first independent network element being configured to carry a first business at the first network slice; and
determine at least one second network slice, a second network slice including a second independent network element and calling the first shared network element, the second independent network element being configured to carry a second business at the second network slice, and the first shared network element being configured to carry the first business and the second business.

16. The device according to claim 15, wherein:
the one or more processors are further configured to:
configure a label, the first shared network element, the first independent network element, a first network interface, and a first business parameter for each first network slice of the at least one first network slice; and
configure a label, the second independent network element, a second network interface, and a second business parameter for each second network slice of the at least one second network slice; and
the at least one second network slice calls the first shared network element through the first network interface and the second network interface.

17. The device according to claim 16, wherein:
the second independent network element includes a second shared sub-network element and a second independent sub-network element;
the one or more processors are further configured to:
determine at least one third network slice including a third independent network element, the third independent network element being configured to carry the third business at the third network slice; and
the third network slice calls the first shared network element and the second shared network element, the second shared network element being configured to carry the second business and the third business, and the first shared network element being configured to carry the first business, the second business, and the third business.

18. The device according to claim 14, wherein the one or more processors are further configured to:
in response to obtaining a business deletion instruction, delete the independent network element corresponding to the business to delete the network slice corresponding to the independent network element.

19. The device according to claim 14, wherein:
each network slice includes two element containers of a same type running at different network nodes; and
when a network element container of any one network node fails, a network element container of the other network node is started.

20. The device according to claim 14, wherein each network slice has a different business parameter.
